(19) United States
(12) Patent Application Publication
(10) Pub. No.: US 2019/0021939 A1
(43) Pub. Date: Jan. 24, 2019

(54) WEARABLE MASSAGE APPARATUS

(71) Applicant: Dana Angelica Forbes, Naples, FL (US)

(72) Inventor: Dana Angelica Forbes, Naples, FL (US)

(21) Appl. No.: 15/884,753

(22) Filed: Jan. 31, 2018

Related U.S. Application Data
(60) Provisional application No. 62/534,522, filed on Jul. 19, 2017.

(51) Int. Cl. A61H 7/00; A41B 1/08; A41D 1/06; A41D 27/02

(52) U.S. Cl. CPC A61H 7/002; A41D 2600/00; A41D 1/06; A41D 27/02; A41D 2400/322; A61H 2201/0157; A61H 2201/1619; A61H 2201/1623; A61H 2201/1628; A61H 2201/1635; A61H 2201/164; A61H 2201/1647; A61H 2201/165; A61H 2201/1692; A61H 2201/1695; A41B 1/08

(57) ABSTRACT

Partial or whole-body therapeutic articles of clothing are provided. Each therapeutic article of clothing provides a plurality of massage protrusions disposed along an inner surface thereof for massaging, relaxing, stress relieving, and skin stimulating certain locations of the wearer's body. The inner surface may be of an elastic nature to urge the plurality of massage protrusions into the skin when each article of clothing is being worn. The massage protrusions may come in many forms and dimensions, and may be spaced apart in random or predetermined patterns to operatively associate with the portions of the wearer most in need of a pressure massage.

### CROSS-REFERENCE TO RELATED APPLICATION

This application claims the benefit of priority of U.S. provisional application No. 62/534,522, filed 19 Jul. 2017, the contents of which are herein incorporated by reference.

### BACKGROUND OF THE INVENTION

The present invention relates to wearable massage apparatuses and, more particularly, to unique partial or whole-body articles of clothing providing a plurality of massage protrusions disposed along an inner surface thereof for massaging, relaxing, stress relieving, and skin stimulating certain locations of the wearer's body.

These days, it seems, are more stressful and tense then ever: people are working longer hours and so have less and less time for themselves to relax or for a massage. We run from work to the gym—if possible—if not directly home to take care of our families. After staying on our feet for long periods of time or sitting down all day at work, or even after exercise, one's legs and body accumulate water, sometime swelling and becoming painful and tight. In such moments a massage or just a pressure massage could bring much needed relief. But we are too tired to do this.

There is plenty of scientific study about soft tissue trigger points; specifically, that mammals suffer from sensitive spots in their soft tissue. Most people find the easiest solution to get rid of the pain or discomfort is a just little rubbing. It works because the rubbing literally pushes and flushing waste metabolites out of skin—at the trigger points.

One can wear elastic clothing, such as spandex, to add a little pressure to one's skin, but this pressure cannot target problem zones, rather such pressure is generally uniform over the surface area of the elastic material, but does not stimulate or trigger the soft tissue trigger points. One cannot have deeper, distributed pressure along specific parts of the body, considered “problem zones”, or where one would specifically like to have a pressure massage.

Furthermore, almost all women have to fight with the little annoying bumps that start building under the skin after certain age making the skin looking untied and old. Aging makes it harder and harder to keep the cellulite from being noticeable on the buttocks and legs. After initially using all kind of creams and diets to try and get rid of them, most women eventually accept them as a part of their body. Thus, most people are willing to try to take simple measures to reduce the look of dimpled legs, buttocks, and arms, but few are aware of the simple measures embodied in the unique invention disclosed below.

As can be seen, there is a need for unique partial or whole-body articles of clothing providing a plurality of massage protrusions disposed along an inner surface thereof for massaging, relaxing, stress relieving, and skin stimulating certain locations of the wearer's body. The plurality of massage protrusions may be disposed so as to located in the abovementioned problem zones for providing localized pressure massage, urged by elasticity of the articles of clothing, stimulating lymphatic flow, blood flow, and other muscle, skin, and fascia-related ailments, such as “heavy legs”.

The present invention also provides a unique, simple solution to help with cellulite reversion. By wearing the thorny clothes embodied in the present invention for say 30 minutes to one hour, the little silicon bumps of the massage protrusions will press against the skin leaving impression on the skin, and when they fade the cellulite appearance is less noticeable.

By stimulating the skin and pressure points in the body, which can trigger production of endorphins and oxytocin—everyone's inherent feel-good hormones, the present invention can result in the relief of pain and stress without taking medicine. It can give the user a relaxing feeling and thus may help with better sleep. Having the silicon cones, pyramid spread all over the clothing, the flexible and lightweight present invention can perform an overall stimulation of the skin, and not just a small portion of an arm, leg, or portion of the core. By infusing the silicon with an essential oil a wearer can have an extra relaxing, stimulating feeling for a shorter period of time.

The plurality of massage protrusions may form lines, waves and the like, in random or predetermined patterns along the inner surface so as to target said problem zones such as the legs, the abdomen, the arms of the wearer. The articles of clothing may be made of stretchy material so as to press the plurality of massage protrusions against the body of the wearer, performing a kind of press massage, helping to relax the muscle and to release accumulated water and toxins.

The articles of clothing may be adapted to be worn on different parts of the human body. For example, the articles of clothing may be adapted to be worn on just the lower torso or just the upper torso. Furthermore, the articles of clothing may be adapted to be a cap for the head of a human wearer, and so on.

### SUMMARY OF THE INVENTION

In one aspect of the present invention, a therapeutic article of clothing includes an elastic material adapted to be worn by a human wearer; the elastic material having an inner surface; and a plurality of spaced apart massage protrusion provided along the inner surface so that the plurality of spaced apart massage protrusion is located against a wearer's skin when said therapeutic article of clothing is worn.

In another aspect of the present invention, some of the plurality of massage protrusions are generally pyramidic.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention, shown in use with the massage protrusions shown schematically in hidden lines;

FIG. 2A is an elevation view of an exemplary embodiment of the present invention, shown inside-out;

FIG. 2B is an elevation view of an exemplary embodiment of the present invention, shown inside-out;

FIG. 2C is an elevation view of an exemplary embodiment of the present invention, shown inside-out;

FIG. 2D is an elevation view of an exemplary embodiment of the present invention, shown inside-out;

FIG. 3A is a detail perspective view of an exemplary embodiment of the present invention;

FIG. 3B is a detail perspective view of an exemplary embodiment of the present invention;

FIG. 3C is a detail perspective view of an exemplary embodiment of the present invention;

FIG. 3D is a detail perspective view of an exemplary embodiment of the present invention;

FIG. 3E is a detail perspective view of an exemplary embodiment of the present invention;

FIG. 3F is a detail perspective view of an exemplary embodiment of the present invention; and

FIG. 3G is a detail perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides unique partial or whole-body articles of clothing providing a plurality of massage protrusions disposed along an inner surface thereof for massaging, relaxing, stress relieving, and skin stimulating certain locations of the wearer's body. The inner surface may be of an elastic nature to urge the plurality of massage protrusions into the skin when each article of clothing is being worn. The massage protrusions may come in many forms and dimensions, and spaced apart in random or predetermined patterns to operatively associate with the portions of the wearer most in need of a pressure massage.

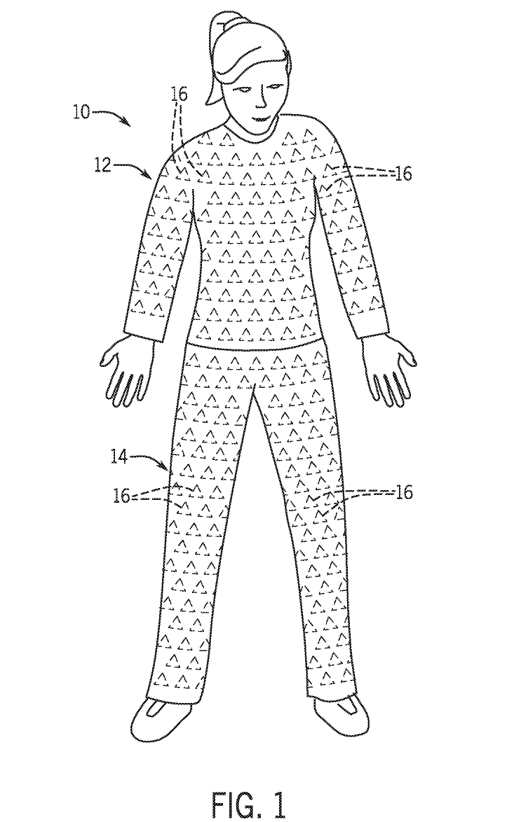

Referring to FIGS. 1 through 3G, the present invention may include a therapeutic article of clothing 10 providing a plurality of massage protrusions 16 disposed along an inner surface 25 of the article of clothing 10 for massaging the wearer in predetermined locations along their body.

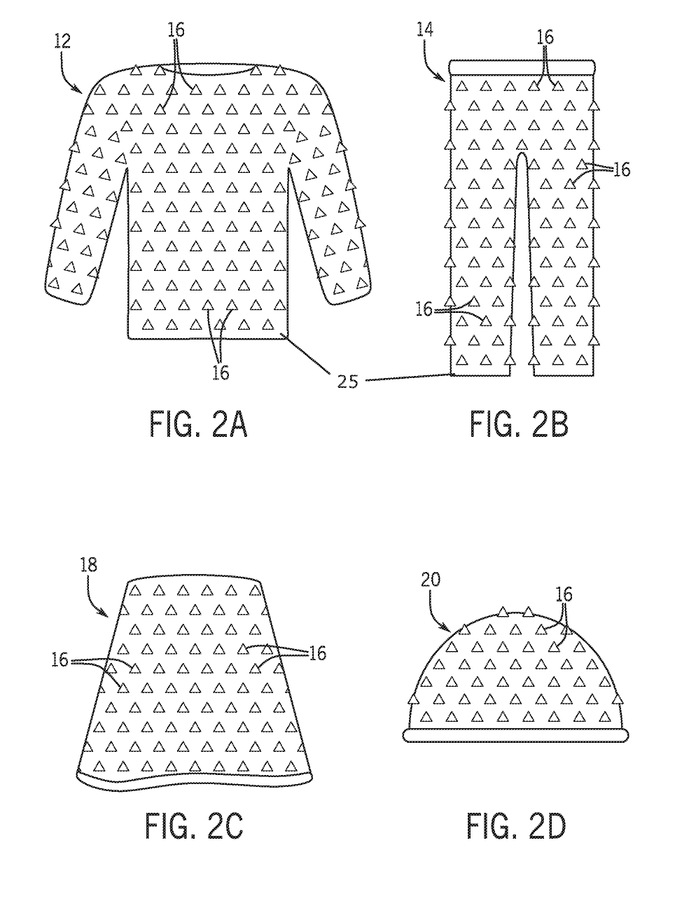

Referring to FIGS. 2A through 2D, each therapeutic article of clothing 10 may be adapted to be worn by a human user so that the plurality of massage protrusions 16 are located at problem zones along the body of the human wearer when the relevant wearable apparatus 10 is worn. In certain embodiments, the therapeutic article of clothing 10 may be adapted to engage the upper torso in the form of an upper garment 12, the lower torso in the form of a lower garment 14 or 16, and/or an upper portion of the head in the form of headgear 20. The material of the therapeutic article of clothing 10 may be a stretchable fabric including at least 5% spandex. The therapeutic article of clothing 10 may be dimensioned so that the inner surface 25 is urged against the portion of the wearer engaging the therapeutic article of clothing 10. The therapeutic article of clothing 10 could be used for sporting goods undergarments, belts, support bandage, anti-cellulite wraps, and other wearable articles.

The plurality of massage protrusions 16 may form lines, waves and the like, in random or predetermined patterns along the inner surface 25 so as to target problem zones such as the legs, the abdomen, the arms of the wearer. The articles of clothing 10 may be made of stretchy material so as to urge the plurality of massage protrusions 16 against the body of the wearer, performing a kind of press massage, helping to relax the muscle and to release accumulated water and toxins.

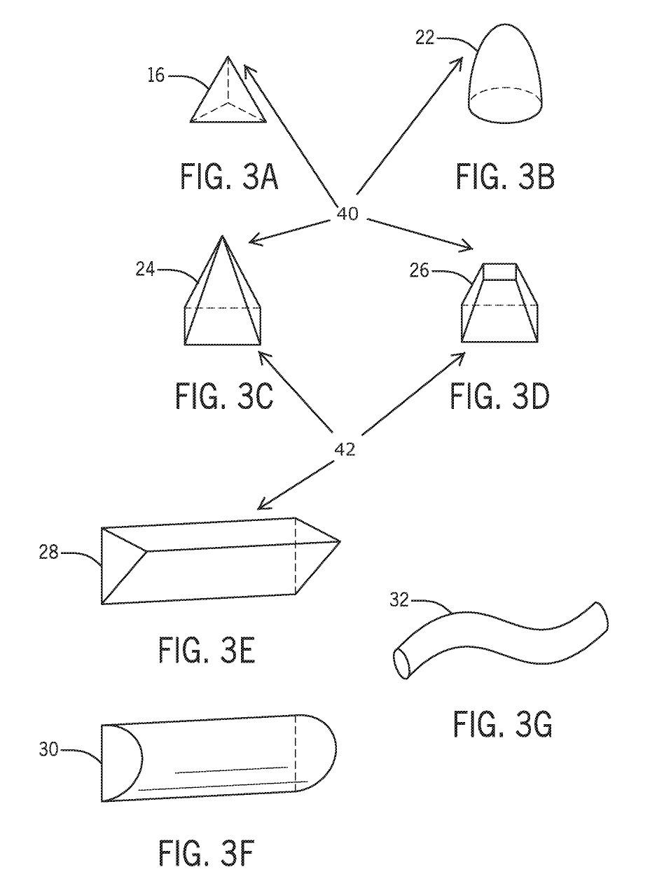

Referring to FIGS. 3A through 3G, the plurality of massage protrusions 16 may be made of sufficiently hard, yet washable material, such as silicon and formed into various shapes. In certain embodiments, the shape may be conical with a tapered upper profile 40 defining pyramidic shapes 16 and 24, defining a pyramidic flat-top 26 upper profile, defining a rounded head 22 upper profile, and/or an elongated prism edged 28 or rounded 30 upper profile, wherein the base profile 42 is a flat surface for engaging the inner surface 25 of each therapeutic article of clothing 10, typically through a mechanism of adhesion of other joining method. Thus, the base profile 42 is typically wider than the upper profile 40, which is thinner, sharper, round or other geometrical form for operatively associating with the skin of a wearer. The upper and lower profile may form noodle shaped 32 protrusions 16. The arrangement and elevations of different forms of protrusions 16 (finger, thorns, cones, pyramids, lines, and/or waves) can be unsymmetrical or symmetrical in form, having a random or predetermined pattern of lines or waves. The silicon thorns, cones, dabs can be between 2-10 mm (0.078-0.393 inch) in diameter at the base, 1-10 mm (0.0393-0.393 inch) on the top, and 2-10 mm (0.078-0.393 inch) in height between the lower and upper profile 42 and 40. Space between the cones, dabs, and thorns may be 2-20 mm (0.087-0.787). The raised pattern of lines and waves can have a wider or similar base profile 42 and have the upper profile 40 be from 1-10 mm 0.0393-0.393 inch) in width, and 1-10 mm (0.0393-0.393 inch) in height.

A method of using the present invention may include the following. The therapeutic articles of clothing 10 disclosed above may be provided. A user may wear a desired therapeutic article of clothing 10 wherein the plurality of massage protrusions 16 are disposed along the inner surface 25 so as to operatively engage a problem zone or portion of the wearer's body. By wearing such therapeutic article of clothing 10 for 20 minutes or longer, especially after a long day of standing, sitting, or exercise, and moving around, the plurality of massage protrusions 16—by way of the elastic material along the inner surface 25—will to be urged against the skin of the wearer, performing a kind of press massage and helping the body to eliminate water and harmful toxins, helping to stimulate lymphatic flow, helping to relax our muscle, helping in improving circulation, and possibly helping to fight cellulite. The present invention can add essential oil to the silicon for extra stimulation of the skin.

It should be understood, of course, that the foregoing relates to exemplary embodiments of the invention and that modifications may be made without departing from the spirit and scope of the invention as set forth in the following claims.

What is claimed is:

1. A therapeutic article of clothing, comprising:
elastic material adapted to be worn by a human wearer;
the elastic material having an inner surface; and
a plurality of spaced apart massage protrusion provided along the inner surface so that the plurality of spaced apart massage protrusion is located against a wearer's skin when said therapeutic article of clothing is worn.

2. The therapeutic article of clothing of claim 1, wherein some of the plurality of massage protrusions are generally pyramidic.

3. The therapeutic article of clothing of claim 2, wherein the pyramidic massage protrusions have a base profile that tapers inward to an upper profile.

4. The therapeutic article of clothing of claim 3, wherein the upper profile is parallel with the base profile.

5. The therapeutic article of clothing of claim 3, wherein each pyramidic has a height of approximately five millimeters.

6. The therapeutic article of clothing of claim 3, wherein the upper profile is rounded.

7. The therapeutic article of clothing of claim 1, wherein some of the plurality of massage protrusions are noodle shaped.

8. The therapeutic article of clothing of claim 1, wherein the elastic material is adapted to conform to an upper torso of the human wearer.

9. The therapeutic article of clothing of claim 1, wherein the elastic material is adapted to conform to a lower torso of the human wearer.

10. The therapeutic article of clothing of claim 1, wherein the elastic material is adapted to conform to an upper portion of a head of the human wearer.

11. A method of stimulating lymphatic and blood flow in a human leg, comprising the steps of:
wearing the therapeutic article of clothing of claim 8; and
moving around for at least twenty minutes.
